(19) United States
(12) Patent Application Publication
(10) Pub. No.: US 2013/0284301 A1
(43) Pub. Date: Oct. 31, 2013

(54) STRUCTURAL IMPROVEMENT OF DRAIN PIPE

(71) Applicant: I-Fu CHEN, Taichung City (TW)

(72) Inventor: I-Fu CHEN, Taichung City (TW)

(21) Appl. No.: 13/456,381

(22) Filed: Apr. 26, 2012

(51) Int. Cl. F16L 11/00

(52) U.S. Cl. 138/109

(57) ABSTRACT

The present invention relates to a structural improvement of a drain pipe, which mainly consists of a flexible pipe member combined with a spiral loop at the outer periphery thereof and the interior thereof is in a smooth state, adjacent loops and two ends of the pipe member are respectively installed with a connector for being connected with a water related equipment and a water draining hole of a water draining pipeline, thereby achieving an excellent connection relation by utilizing the two connectors at two ends of the pipe member to connect the water related equipment and the water draining hole of the water draining pipeline, the configuration of the pipe member can be properly bent and adjusted according to the installation space thereby obtaining a smooth water draining effect, and after the pipe member is bent and set, the smoothness of the inner pipe wall can be kept.

### BACKGROUND OF THE INVENTION

1. Field of the Invention

The present invention relates to a structural improvement of a drain pipe, especially a drain pipe which is aimed to solve problems that a conventional drain pipe formed in a bent pipe configuration and made of metal or rigid plastic may cause the connection and assembly of a water related equipment and a water draining hole of a water draining pipeline not being able to be processed or being poorly connected and assembled, due to the location deviation

2. Description of Related Art

For a water related equipment, e.g. a basin, in order to drain the used dirty water to a water draining pipe, a water draining hole is often formed at the bottom of a water storage tank, then is connected to an external water draining pipe, and the other end of the water draining pipe is connected and inserted in a water draining hole preset on a water draining pipeline arranged on a floor or a wall, thereby enabling the dirty water to be guided to the water draining pipeline arranged on the floor through the water draining pipe for achieving the anticipated water draining function.

For the water draining pipe assembly of the mentioned water related equipment, a water draining pipe made of metal or rigid plastic is often adopted as a connection between the water related equipment and a water draining hole formed on a floor, and with respect to the relative relation of the installation location of the water related equipment and the water draining hole of the water draining pipeline, various types of bent pipes have to be selectively used for being mated with the assembly so as to finish the water draining pipe assembly; under the mentioned situation, additional components have to be adopted and the selection of proper components is not convenient and consuming time and labor; if the distance between the location of the water related equipment and the water draining hole of the water draining pipeline is too far or too close, the assembly may not be carried out, or may have to be forced to process which often results in poor assembly, thereby affecting the water draining function and quality, such disadvantage shall be improved.

For solving the mentioned problem that the water draining pipe made of metal or rigid plastic may face issues caused by the water related equipment and the location of the water draining hole of the water draining pipeline being overly deviated, the skilled people in the arts use a bellow soft pipe for serving as a water draining pipe, so the bellow soft pipe can be properly bent and adjusted with respect to the installation space, thereby finishing the installation of the water draining pipe. However, the bendable property of the bellow soft pipe is achieved by the space created by plural adjacent loops, and the loops are designed to have convex interiors and concave exteriors, or concave interiors and convex exteriors, i.e. the inner pipe wall of the bellow soft pipe is not smooth and is in a convex/concave state; the water draining function is still provided, but the convex/cave interior may accumulate water incrustations, hairs or debris, so in the long term, the interior of the water draining pipe is inevitably getting narrower, a problem of unsmooth water draining is caused; therefore the bellow soft pipe is not best choice for replacing the conventional water draining pipe and a novel design shall be provided.

### SUMMARY OF THE INVENTION

In view of that there is no ideal solution for assembling a water related equipment and a water draining hole of a water draining pipeline, the applicant of the present invention has devoted himself to improve the shortage of convention arts, and with his comprehensive experience and knowledge relative to this field, a novel structure of a drain pipe in which the assembly is not restrained by space thereby being enabled to be properly bent and adjusted with respect to the space so as to smoothly finish the assembly.

Another objective of the present invention is to provide a structural design in which the assembly of a water draining pipe can be smoothly finished without being restrained by space, and the smoothness of the inner pipe wall can also be ensured, thereby effectively avoiding occurrences of accumulating water incrustations or hairs or debris, so the normal water draining function can be kept.

One another objective of the present invention is to provide a structure in which an excellent connection relation can be achieved by utilizing connectors installed at two ends for connecting a water related equipment and a water draining hole of a water draining pipeline.

For achieving the mentioned objectives, the present invention provides a structural design which mainly consists of a pipe member made of a material having the flexible property, and the outer periphery thereof is covered by a spiral loop, adjacently loops of the spiral loop are spaced with a predetermined interval, and two ends of the pipe member are respectively installed with a connector for connecting a water related equipment and a water draining hole of a water draining pipeline; so with spiral loop and the intervals between adjacent loops, the features of bendable and settable are provided, and the smoothness of the inner pipe wall can be ensured, with the excellent connection relation between the connectors at two ends and the water related equipment and the water draining hole of the water draining pipeline, the normal water draining function can be ensured.

### BRIEF DESCRIPTION OF THE DRAWINGS

FIG. 1 is a schematic view showing the structure of pipe member according to one preferred embodiment of the present invention;

FIG. 2 is a schematic structural exploded view according to one preferred embodiment of the present invention;

FIG. 3 is a schematic structural view according to one preferred embodiment of the present invention;

FIG. 4 is a schematic view illustrating the structure relation according to one preferred embodiment of the present invention;

FIG. 5 is a schematic view illustrating the operation state according to one preferred embodiment of the present invention;

FIG. 6 is a schematic view illustrating the operation state according to another preferred embodiment of the present invention; and

FIG. 7 is a schematic view illustrating the operation state according to one another preferred embodiment of the present invention.

### DESCRIPTION OF MAIN COMPONENT SYMBOLS

10 Pipe member
20 Spiral loop
30, 40 Connector
50 Water related equipment
51 Water draining joint
60 Floor
60′ Wall
61 Water draining hole

### DETAILED DESCRIPTION OF THE PREFERRED EMBODIMENT

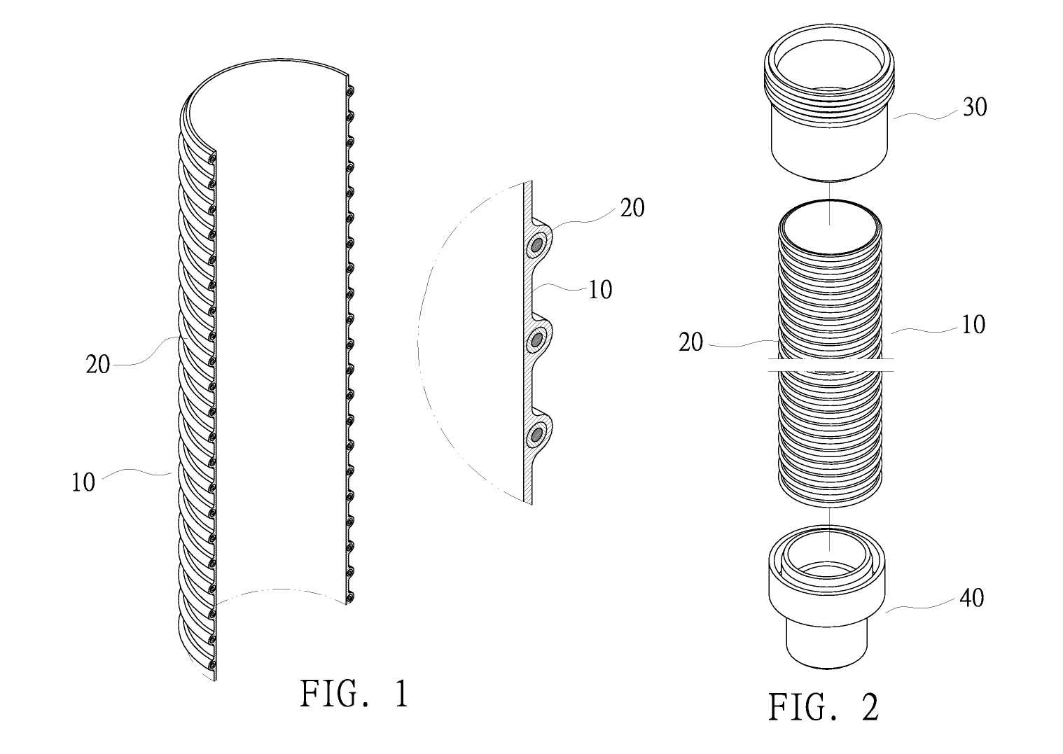

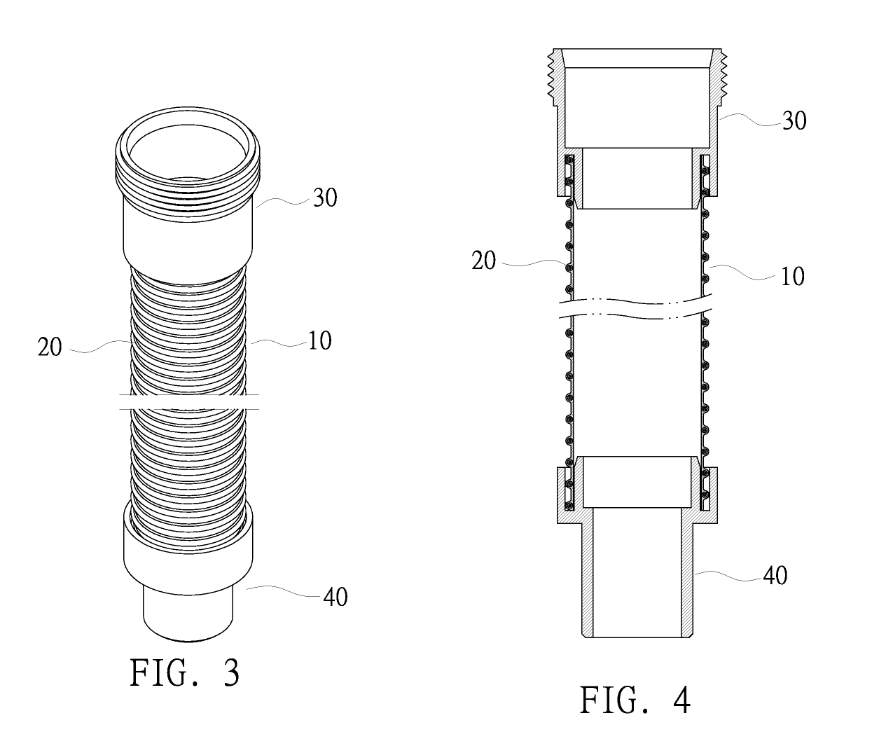

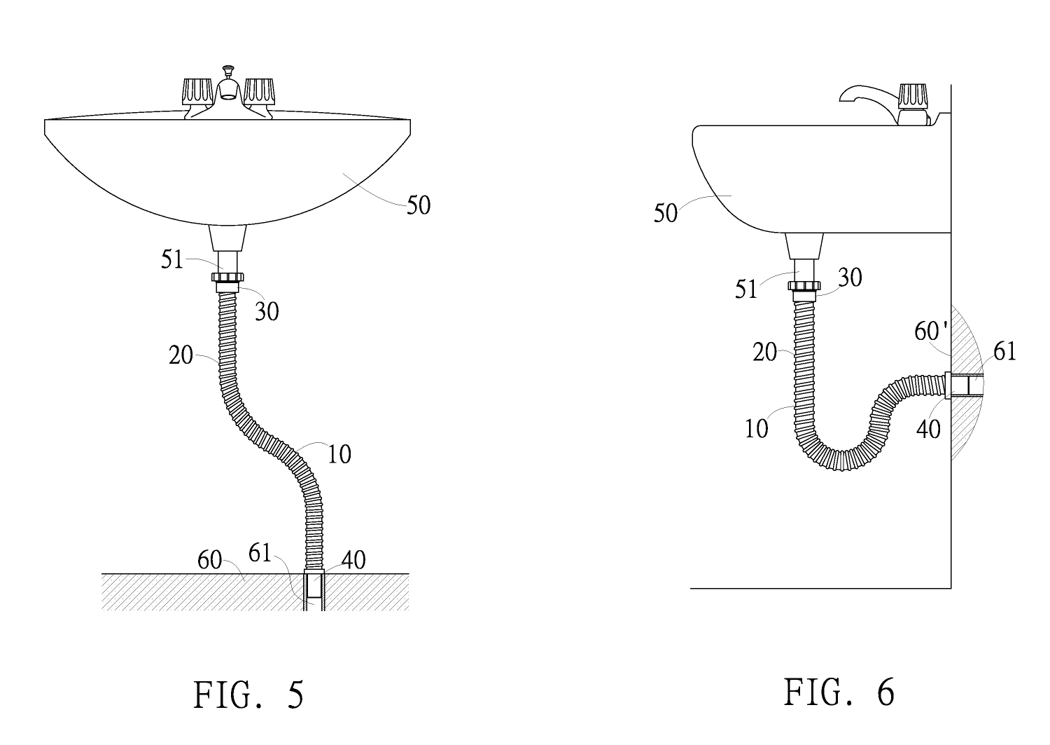

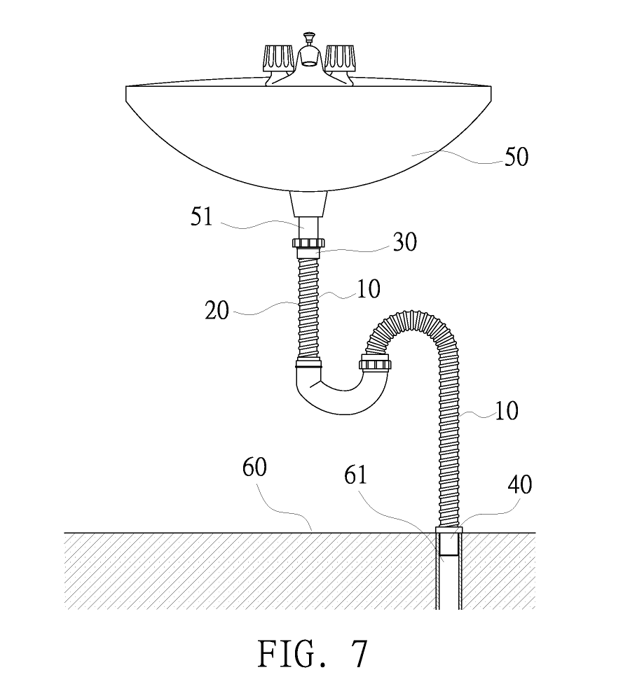

The present invention will be apparent to those skilled in the art by reading the following detailed description of a preferred embodiment thereof, with reference to the attached drawings, in which: FIG. 1 is a schematic view showing the structure of pipe member according to one preferred embodiment of the present invention; FIG. 2 is a schematic structural exploded view according to one preferred embodiment of the present invention; FIG. 3 is a schematic structural view according to one preferred embodiment of the present invention; FIG. 4 is a schematic view illustrating the structure relation according to one preferred embodiment of the present invention; and FIG. 5 to FIG. 7 are schematic views illustrating the operation state according to preferred embodiments of the present invention.

As shown in figures and according to one preferred embodiment of the present invention, a structural improvement of a drain pipe mainly consists of a pipe member (10) having a predetermined length, and the pipe member (10) is made of a flexible material; during the formation of the pipe member (10), the outer periphery of the pipe member (10) is integrally formed with a spiral loop (20) which is made of a material such as metal or rigid material thereby reinforcing the structural strength of the pipe member (10), and also providing a settable feature, and the installation of the spiral loop (20) would not affect the smoothness of the inner pipe wall of the pipe member (10), and adjacent loops of the spiral loop (20) are spaced with a predetermined interval, thereby providing allowance for compressing and bending; and two ends of the pipe member (10) are respectively installed with a connector (30), (40) having a predetermined configuration; the means of combining the connectors (30), (40) and the pipe member (10) can be carried out by disposing the pipe member (10) in a mold which is used for molding the connectors (30), (40), thereby achieving an integral formation effect; and the types and specifications of the connectors (30), (40) can be varied with respect to a water draining joint (51) of a water related equipment (50), e.g. a basin and a water draining hole (61) formed on a water draining pipeline installed on a floor (60) or a wall (60′); one of the connectors (30), (40) can also be formed as a bent pipe or other configurations according to the requirement of the designed installation, thereby providing the structure having the essential function invented by the present invention.

When the drain pipe of the present invention is in use, for connecting and assembling the water draining joint (51) of the water related equipment (50) and the water draining hole (61) formed on the water draining pipeline installed on the floor (60) or the wall (60′), the connector (30) mated with the water draining joint (51) of the water related equipment (50) can be adopted for finishing the connection and assembly of the pipe member (10) and the water related equipment (50), then the pipe member (10) is properly bent and adjusted with respect to the installation space and the location of the water draining hole (61) formed on the water draining pipeline installed on the floor (60) or the wall (60′), or two or more pipe members (10) can be used to work with the connectors having the bent pipe configuration, thereby the connector (40) at the other end of the pipe member (10) being enabled to be connected and inserted in the water draining hole (61) of the water draining pipeline, and the assembly of the drain pipe is therefore finished.

During the assembly process of the mentioned drain pipe, because the pipe member (10) has properties of flexible and settable, the water related equipment (50) and the water draining hole (61) formed on the water draining pipeline installed on the floor (60) or the wall (60′) are enabled to be connected in an optimal state through the pipe member (10) being adjusted and bent according to the installation space; and after the assembly is finished, the smoothness at the inner pipe wall of the pipe member (10) can still be ensured, thereby avoiding the problem of accumulating water incrustations or hairs or cottons or debris, the normal water draining function can be therefore kept.

In addition, two ends of the pipe member (10) are respectively formed the connectors (30), (40), so when the pipe member (10) is used to connect the water draining joint (50) of the water related equipment (50) and the water draining hole (61) formed on the water draining pipeline installed on the floor (60) or the wall (60′), a simplified operation can be provided and an excellent connection relationship can be obtained, thereby further increasing the convenience and quality of the whole assembly operation of the drain pipe.

As what is disclosed above, the present invention utilizes a structural design of the drain pipe in which a pipe member having bendable and adjustable properties being adopted for replacing the conventional drain pipe which is made of metal or rigid plastic, so the assembly and connection of the water related equipment and the water draining hole of the water draining pipeline is not restrained by the installation space and the relative locations, thereby easily to finish the assembly operation through properly bending and adjusting, and after the assembly is finished, the smoothness of the inner pipe wall of the pipe member can be kept, thereby effectively avoiding occurrences of accumulating water incrustations or hairs or debris, so the possibilities of the dredging and cleaning requirement in the further can be greatly reduced, and the normal water draining function can be ensured. As such, it is clear that the present invention is novel and practical in industrial applications.

With the drain pipe structure provided by the present invention, the assembly is not restrained by the installation space while the conventional rigid drain pipe is restrained thereby, and in view of the problem of accumulating debris caused by the unsmooth inner pipe wall of a bellow soft pipe, the present invention has advantages of easy in assembly, free from being jammed and plugged by foreign objects. Thus, comparing to the conventional arts, the present invention is novel and practical in industrial applications.

What is claimed is:

1. A structural improvement of a drain pipe, used for connecting a water draining joint of a water related equipment and a water draining hole of a water draining pipeline, the drain pipe includes:
a pipe member tailored to a predetermined length according to the requirement, and made of a material having the flexible property; during the formation of the pipe member, the outer periphery of the pipe member is integrally combined with a spiral loop, thereby providing features of bendable and settable, wherein the inner pipe wall of the pipe member is in a smooth state;
a connector installed at one end of the pipe member for being mated and connected with the water draining joint of the water related equipment;
another connector installed at the other end of the pipe member for being mated and connected with the water draining hole of the water draining pipeline.

2. The structural improvement of the drain pipe as claimed in claim 1, wherein the spiral loop combined at the outer periphery of the pipe member is made of metal.

3. The structural improvement of the drain pipe as claimed in claim 1, wherein on the spiral loop combined on the outer periphery of the pipe member, adjacent loops are spaced with a predetermined interval.

4. The structural improvement of the drain pipe as claimed in claim 1, wherein the pipe member and the connectors at two ends are integrally formed during the molding of the connectors.

5. The structural improvement of the drain pipe as claimed in claim 1, wherein the connector at one end of the pipe member is formed as a predetermined bent pipe configuration, so a drain pipe arrangement formed by two or more than two pipe members is enabled to be achieved according to the space limitation.
